(19) United States
(12) Patent Application Publication
(10) Pub. No.: US 2010/0191978 A1
(43) Pub. Date: Jul. 29, 2010

(54) Method For The Parameterization And Operation Of Weighing Scales

(75) Inventor: Helmut Pfau, Bodelshausen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIZERBA GMBH & CO. KG, BALINGEN (DE)

(21) Appl. No.: 12/531,870

(22) PCT Filed: Mar. 19, 2008
(86) PCT No.: PCT/EP08/02219

§ 371 Date: Mar. 18, 2010

(30) Foreign Application Priority Data
Mar. 20, 2007 (DE) 10 2007 013 333.4

(51) Int. Cl. G06F 12/14; G01G 9/00; G06F 15/00

(52) U.S. Cl. 713/189; 177/1; 702/173; 726/27; 177/25.13

(57) ABSTRACT

The invention relates to a method for the parameterization of scales which have a weighing belt for the weighing of products in a conveying process, wherein a teach procedure and subsequently a verification procedure take place after the input of product-specific data. The invention furthermore relates to a method for the operation of scales parameterized in this manner.

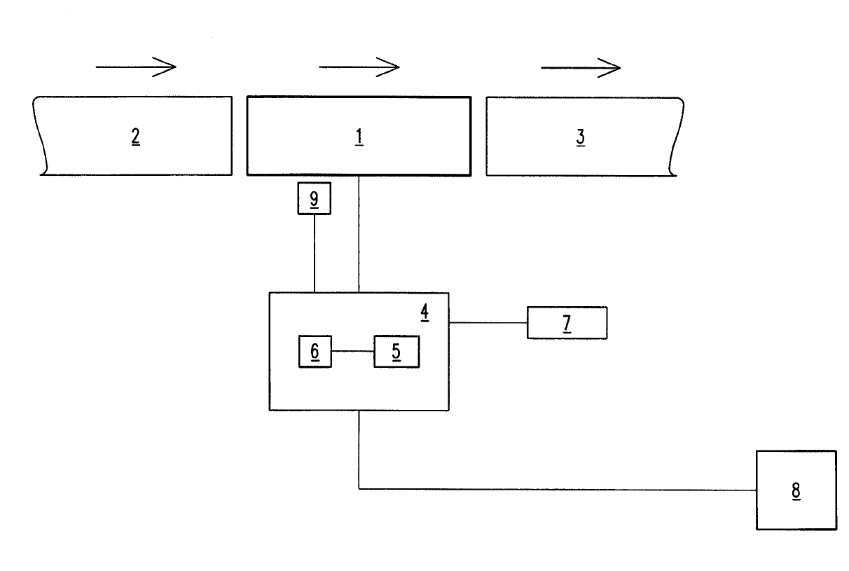

The present invention relates to a method for the parameterization and for the operation of scales which have a weighing belt for the weighing of products in a conveying process.

Scales of this type are used, for example, as checkweighers with which the weight of products of substantially the same weight and following one another at high speed in a conveying process can be determined within a very short time in order to ensure in this manner, for example, that the existing EU Prepacked Product Directive is observed. Furthermore, such scales are also used in connection with price labeling systems in which the individual weight of products following one another and as a rule having different weights each have to be determined as precisely as possible likewise within a very short time.

A goal is generally to achieve a product throughput which is as high as possible, with this being understood as the ratio of belt speed to weighing belt length. The weighing belt in whose region the weighing process takes place is usually integrated into a normal product conveying process, which means that it is adjacent to a further conveyor belt at the ingoing and offgoing sides.

As a rule, scales of the named kind are used at their respective location for the weighing of products which are acquired in production processes differing from one another and which differ from one another accordingly. It thus, for example, occurs that on one workday only products of a first product type with a nominal weight of 100 g and a length of 10 cm are weighed, whereupon on another working day products of a second product type with a nominal weight of 150 g and a length of 14 cm are weighed.

The fact is disadvantageous with the scales in accordance with the prior art that they have to be set separately and recalibrated in the presence of a calibration officer for every product type characterized e.g. by nominal weight and product dimension or for an increase in the weighing belt speed and so the throughput to be achieved. Even if it is possible with scales in accordance with the prior art to store settings checked by a calibration officer in the form of parameter data sets for different product types and to activate them as required, the problem remains that on the weighing of new product types or on an increase in the weighing belt speed, the calibration officer again has to appear on site to certify a corresponding new parameter data set.

It is an object of the invention to provide a method for the parameterization of scales which allows a set of scales to be set to a new product type without an inspection by a calibration officer being necessary, with it, however, nevertheless still being ensured that prescribed error tolerances are observed reliably and mandatorily.

This object is satisfied by a method of the initially named kind wherein
in a first step, product-specific data are input into a control unit which is used for the determination of control parameters;
in a second step, a filter function is determined in an automated manner which is matched to the respective product and which is to be applied to the time-dependent course of a weight signal;
in a third step, automatic verification is made by means of the weighing of products whether the weight values obtained using the previously determined control parameters and the previously determined filter function lie within preset tolerances;
with a data set which is secured against manipulation and which includes at least the control parameters, the filter function and a product identification only being stored in the control unit with a positive verification.

In accordance with the invention, a new product type is therefore defined in the first step by the input, in particular manual input, of data specific to a product type, whereupon, in a second step, a teach procedure runs in the course of which a mathematical or electronic filter function is determined which smoothes the time-dependent course of the weight signals determined in the subsequent normal operation of the scales in a sensible manner.

After this second step, with scales in accordance with the prior art, the calibration officer usually checks whether preset tolerances are observed in the operation of the scales with the determined filter function and the determined control parameters. In accordance with the invention, this is now substantially made superfluous by the mandatorily required automatically controlled third step of the parameterization in the course of which it is verified whether the preset tolerances are observed. It is not possible to intervene manually in a manipulating manner in this verification process so that it is ensured that this process always runs in the same, fixedly preset time sequence. It is thus also ensured that every action required for the verification is actually carried out, whereupon, again automatically without a manual intervention possibility, an evaluation is made whether the verification was successful or not. Only in the case of a successful verification is a data set then automatically stored in the control unit of the scales, said data set including at least the control parameters, the filter function and a product identification. If this data set is then activated later in the operation of the scales, it is ensured that the set control parameters and the set filter function ensure a proper operation of the scales within the preset tolerances for the respective product type since precisely these parameters were previously verified in the course of the parameterization.

It is important that the data set stored in the control unit is secured against manipulations so that it is ensured that the scales can actually also only be operated with previously verified parameters and not, for instance, with modified parameters. It is thus, for example, reliably prevented that a previously input conveying speed or a previously input throughput is subsequently increased while accepting unpermitted errors in order to increase the product speed at the scales in a dishonest manner.

The control unit can be fixedly connected to the scales, with an operation of the scales only being permitted when a proper connection is present between the control unit and the scales. The connection of the control unit and the scales can be made electronically and/or mechanically in this case. The presence of an electronic connection can then be checked by means of a check routine for the presence of the connection and/or for the function of the control unit in that e.g. the scales periodically query a check sum stored in a non-modifiable manner in the control device or a corresponding check code when switched on and/or during operation. On an incorrectly transmitted check sum to the scales or on an incorrect check code, an automatically generated error message can, for example, take place or the operation of the scales can be prevented.

If a mechanical connection is provided between the scales and the control device via fixed connection elements (e.g. screws, rivets, clamps), it can be secured against being released by a seal. It is naturally particularly preferred if the control device is accommodated in the actual scale housing.

A correct parameterization, including verification, can in particular be achieved in that the individual parameterization steps are carried out interactively in an order preset, for example by a program and thus enforced by the control unit without an operator being able to make any changes to this order.

The product-specific data to be input in the first step can include a nominal weight or a nominal weight range, a conveying speed or a product throughput, a product length, a product length tolerance and/or a product identification. The input of a nominal weight is in particular sensible in a checkweigher in which a plurality of sequential products should be weighed which have a weight among one another which is as identical as possible. A nominal weight range is, in contrast, preferably input on the use of scales in connection with a price labeling system since as a rule sequential products are weighed here which have weights differing substantially from one another in part, with the price in each case being determined in dependence on the weight determined. It is, however, equally possible with a price labeler to input an average nominal weight instead of a nominal weight range and subsequently to determine the upper limits and lower limits of the nominal weight range empirically during the second and/or third steps in accordance with the invention with reference to the products weighed in the second and/or third steps.

Generally, within the framework of the invention, fewer than the product-specific data named above can also be input. It is, however, also equally possible to input additional product-specific data such as the volume, the product width, the product height, the specific weight or the type of the respective packaging. All the input data can be used for the determination of the respective ideal filter function taking place in the second step.

During the second step, in particular at the start of the second step, a product is weighed statically, that is with a stationary weighing belt, and additionally also dynamically, that is with the weighing belt running. The weight of the respective product can be determined exactly by the static weighing since falsifications due to product movements or due to other forces (for example, lifting forces) acting on the product which arise on the conveying of products are completely avoided. In this respect, a correct weight value is determined in the static weighing which can then be compared with the weight values determined in the dynamic weighing which as a rule have a specific spread about the correct weight value.

To ensure that the conditions given during the carrying out of the second step correspond to those conditions which apply in the normal operation of the scales after their parameterization, the weighing belt is preferably operated at the conveying speed input in the first step in the dynamic weighing. It is thus ensured that the product movements and forces occurring in the dynamic weighing correspond to those which also occur subsequently in normal operation.

It is particularly advantageous if, during the second step, a product is weighed once statically with a stationary weighing belt and multiple times dynamically with the weighing belt running. A single static weighing is sufficient to obtain a correct weight value. A multiple dynamic weighing allows the weight values determined to be evaluated statically and to be checked particularly well with respect to their reliability. A typical curve of the weight signals obtained in the dynamic weighing can thus therefore be determined so that subsequently the respective best suitable filter function can be determined in dependence on this typical time-dependent course and on the input product-specific data.

A particularly good determination of the best suitable filter function can be effected if, during the second step, not only one product, but two to ten products, in particular two to four products, are subjected to the named weighing processes, with these products being as different as possible from one another with respect to weight and shape or length. Typical weight signal curves can thus be obtained which cover the total spectrum of the respective product type which can be considered with respect to weight and shape or length of the products.

In particular when scales should be used with a price labeling system which permits a nominal weight range instead of a specific nominal weight, it is sensible to weight a plurality of products in the second step whose weights cover this total nominal weight region.

When determining the optimized filter function at the end of the second step, known methods from the prior art can be used such as are described in the documents EP 1 625 367 B1, EP 1 416 631 A2 and EP 1 363 112 A1.

After completion of the second step, which substantially serves to determine the respective ideal filter function for a product type within the framework of a teach process, the third step which is mandatorily required in accordance with the invention is carried out in whose course it is verified whether permitted and correct weight values which are within the preset error tolerances can be determined with the determined filter function and with the other set control parameters, in particular the set conveying speed or the set throughput.

Analog to the second step, it is preferred if at least one product is also weighed statically and dynamically during the third step, with the weighing belt in turn in particular being operated at the conveying speed input in the first step in the dynamic weighing.

It is also sensible in the third step to weigh a product once statically and a multiple of times dynamically, with it having been found that the ten-time dynamic weighing can deliver a sensible spread of the determined weight curves. It is, however, also easily possible to weigh dynamically more or fewer than ten times.

Analog to the second step, two to ten different products, in particular two to four different products are also weighed statically and dynamically in the third step, with these products again also having differences with are as large as possible with respect to their weight and their shape or length.

Care must be taken with respect to the number of the products weighed in the second and/or third steps and the number of dynamic weighings of each of these products that the product from both numbers is so large, on the one hand, that sensible calculations can be made and is so small, on the other hand, that the third step does not take up too much time. It is sensible to achieve this if the product from both numbers adopts values between 10 and 200, in particular between 20 and 40.

It is preferred if a standard deviation and/or a mean deviation is/are determined for the weight values determined with the dynamic weighing procedures of the third step and/or if a determination is made for the weight values determined with the dynamic weighing procedures of the third step whether they are within preset calibration error limits. It can thus be determined at the end of the third step whether the determined standard deviations and/or mean deviations and/or weight values are within preset limit values. If it is found that this is the case on this check, this means that the verification has taken place positively, which then has the consequence that a data set is stored in the control unit of the scales which is secured against manipulation and which at least includes the control parameters determined on the basis of the input product-specific data, the filter function determined in the second step and a product identification. This data set can then be activated at a later time and can fix the operating data of the scales by its activation without a user being able to change these operating data.

If, however, it is found at the end of the third step that the determined standard deviations and/or mean deviations are outside the preset limit values, no data set is stored in the control unit which can subsequently be used for the operation of the scales. A new parameterization must rather be carried out since data sets which can be used for the normal operation of the scales are generally only stored in the control unit when the verification has led to a positive result within the framework of the parameterization.

It is particularly advantageous if the data set stored in the control unit and secured against manipulation can only be made deactivatable as required, but cannot be completely deleted. It can be achieved in this manner that, for example, a calibration officer can check at any desired times all the data sets which had ever been stored as positively verified, which ultimately means that the total “parameterization history” of a set of scales is permanently available. Such a parameterization history is in particular stored separately for each product type so that at least the times can be traced at which the data set applicable to a respective product type was in each case changed via a new parameterization. In this case, all the earlier data sets relating to the respective product type can admittedly still be checkable, but only the last data set created for this product type can be activated.

It is particularly advantageous if the data set secured against manipulation additionally includes a verification date, a verification time, a running number related to the respective verification and/or at least one check key. The chronology of the successful verifications can be traced at any time, in particular while assigning specific verification times, by the verification date, verification time and/or running number. It is advantageous if the data set additionally includes a code which identifies that person who carried out the respective parameterization since the person respectively responsible for the parameterization can thus be determined subsequently.

It can be ensured by means of the named check code that the stored data set can no longer be changed at a later date. If a change is nevertheless made to the data set, the check code determined in dependence on the stored data of the data set no longer matches the stored data so that such an illegally changed data set can be recognized and then rejected or blocked. It can therefore be ensured by the named check code that the data set stored in the control unit is secured against manipulation in the manner in accordance with the invention.

An additional security can be achieved in that the data set secured against manipulation or a part thereof is stored on a secured memory medium, in particular on a chip. The securing can be realized in any desired manner in this respect. It is, for example, possible to provide the memory medium with a seal or to encode the stored data or to couple them with a signature. It is finally also possible only to provide a sufficient security in that a soldered chip is used as the memory medium which can no longer be easily removed due to the existing solder connection.

Data stored on such a memory medium cannot easily be accessed for changing or deleting. A data set stored on such a memory medium can—but does not have to—be provided with an additionally securing check code.

It is also possible only to store parts of the data set on a memory medium secured in the described manner and to store the remaining parts of the data set in a normal memory of the control unit, with these remaining parts then having to be secured by a check code. It is, for example, sensible only to store a verification date and/or a verification time and a reference on the secured memory medium, said reference enabling an assignment to the remaining parts of the data set which are stored in the normal memory of the control unit and which are in turn secured by a check code.

In an advantageous method for the operation of a set of scales parameterized in accordance with the invention, it is ensured that the scales can only be operated with data sets secured against manipulation or only with a lower performance (throughput) licensed by a licensing authority independently of the respective product type. The operation of the scales using control parameters which were fixed arbitrarily by an operator without parameterization in accordance with the invention and which result in a performance above the performance licensed independently of the product is generally blocked in this process.

A method for the operation of a set of scales can be designed particularly comfortably when that data set secured against manipulation is activated at the start of the normal operation whose product identification coincides with a product identification input or detected at the start of operation. Such a product identification is preferably detected by means of a scanner or a camera so that the activation of the associated data set can then take place automatically. If a product identification is detected for which no matching verified data set is present, an operation of the scales is only permitted with a low performance certified by a calibration officer independently of the product.

Provision is preferably made that not only a product type, but rather different product types can be processed during normal, ongoing operation. For this purpose, the data set belonging to a respective product type can be called up or activated manually before the first product of this product type is weighed. It is, however, of advantage if the data set belonging to a product type is activated automatically in dependence on a product identification, with such a product identification preferably being located on the product itself. For this purpose, the product can have a code readable via an optical reading device, e.g. a barcode or a 2D code. The product can, however, equally also have a code readable via an electronic reading device, for example in the form of an RFID chip. Within the framework of the automatic product type recognition, the switching between different stored data sets of the product types consequently takes place automatically during operation without a stopping of the weighing process or a manual intervention being necessary for this purpose.

If the scales parameterized in accordance with the invention are used as a checkweigher or in connection with a price labeling system, it is sensible—as already mentioned—to input a nominal weight range having an upper limit and a lower limit in the parameterization in the first step. It is alternatively also possible to determine an upper limit and a lower limit empirically in the second and/or third steps in that the determined weight values of the lightest and heaviest products used in the second and/or third steps are simply used of this purpose.

The range between the lower limit reduced by a tolerance value and the upper limit increased by a tolerance value then represents a trust range which is related to the weight and which was taken into account within the framework of the parameterization and in which a proper operation of the scales is ensured. In the normal operation of the scales, only those products are then accepted whose determined weight lies within the named trust range. An acceptance in particular always takes place when the upper limit is not exceeded by more than x % or when the lower limit is not fallen below by more than y %, where the following applies: 0≦x20 and 0≦y≦20. In particular x=y applies in this context.

If a product is not accepted, it can e.g. be expelled. It is equally possible to mark such a product in a suitable manner. In a price labeling system, a non-accepted product can e.g. be marked in that, unlike the accepted products, it is not provided with a label.

This described procedure of the acceptance check takes place in this respect to ensure that only those products are labeled whose weight is within a range which had previously also been taken into account in the second and/or third steps, in particular in the verification. If namely, for example, the verification was carried out with a nominal weight range between 100 g and 200 g, it can be assumed that—in the case of “x, y=10”—the scales are weighing correctly in a range between 90 g and 220 g, with it, however, being possible that, for example, erroneous values are delivered at a weight of 300 g. It is sensible in this respect not to accept such a product which weighs more than 220 or less than 90 g.

Alternatively or additionally to the described acceptance check described with respect to the weight of the products, an acceptance check can also be carried out with respect to product dimensions, in particular with respect to the product length. It is necessary for this purpose to provide sensors in the region of the scales for the detection of the dimensions or of the length of all products passing the scales.

An acceptance check will be described in the following with respect to product dimensions for the example of the check of the product length. Alternatively or additionally, however, other product dimensions can also be taken into account such as the width, the height and/or the volume of the products.

Different product lengths occur because, among other things, products come to lie on the weighing belt with different angular orientations so that their projection length then also varies on a vertical plane extending parallel to the direction of conveying if the products are the same among one another. The product length is usually detected by light barriers which are arranged at both sides of a conveying means and whose light beams extend parallel to the conveying plane. Such light barriers can only detect the projection length of the products on a vertical plane extending parallel to the direction of conveying.

A product having a quadratic base surface lying on the weighing belt will appear correspondingly smaller if the edges of the base surface extend parallel and perpendicular to the conveying direction and appear longer when the edges extend at an angle of e.g. 45° to the conveying direction. It is already sensible solely due to the facts described above to provide the product length tolerance initially mentioned.

With an acceptance check with respect to the product length, a product length and a product length tolerance are input in the parameterization in the first step from which a length range with an upper limit and with a lower limit can be calculated. Alternatively, it is also possible to determine an upper limit and a lower limit empirically in the second and/or third steps in that, for this purpose, the determined length values of the longest and shortest products used in the second and/or third steps are simply made use of.

The range between the lower limit reduced by a tolerance value and the upper limit increased by a tolerance value then represents a trust range—related to product length this time—which was taken into account within the framework of the parameterization and in which a proper operation of the scales is ensured. In the normal operation of the scales, only those products are then accepted whose determined lengths are within the named trust range. An acceptance in particular always takes place when the upper limit is not exceeded by more than x % or when the lower limit is not fallen below by more than y %, where the following again applies: 0≦x≦20 and 0≦y≦20. x=y also in particular applies here in this respect.

If a product is not accepted, it can equally be expelled or marked as has already been explained above.

This described process of the acceptance check takes place in this case to ensure that only those products are labeled whose length lies in a range which was previously also taken into account in the second and/or third steps, in particular in the verification. If namely, for example, the verification was carried out with a length region between 10 cm and 15 cm, it can be assumed that the scales—in the case of “x, y=20”—weighs products correctly with a length in a range between 8 cm and 18 cm, with it, however, being possible that, for example, erroneous values are delivered with a length of 20 cm. In this respect, it is sensible not to accept a product which is shorter than 8 cm or longer than 18 cm.

It is furthermore advantageous if the ambient temperature set in the parameterization is detected by means of a temperature sensor during the parameterization and an operation of the scales is blocked at temperatures which lie outside a trust temperature range which includes the ambient temperature determined during the parameterization. Alternatively to the named blocking, it can also be allowed to operate the scales only at a low performance (throughput) licensed by a licensing office independently of the respective product type.

To enable the required temperature comparison to be carried out here, the respective current ambient temperature must naturally also be determined during the normal operation, for which purpose the already named temperature sensor preferably integrated into the scales can be used.

The lower limit of the named trust temperature range can in this respect be x° C. below the ambient temperature determined in the parameterization and the upper limit of the trust temperature range can be y° C. above the ambient temperature determined in the parameterization, where 1≦x≦10 and 1≦y≦10 and in particular x=y applies. A value particularly sensible for x and y in practice amounts to 5.

The ambient temperature can e.g. be determined at any time during the first, second or third steps in accordance with the invention. An averaging is equally possible over a time interval which lies within the carrying out of the first, second and/or third steps in accordance with the invention. A trust range is therefore now created here with respect to the temperature within which a proper operation of the scales is ensured. If this range is departed from by the ambient temperature given in the normal operation of the scales, the operation of the scales is either blocked or only allowed at a low performance (throughput) licensed by a licensing office independently of the respective product type.

It must be mentioned in addition that usually a base temperature range in which the scales may be operated is also already fixed by the licensing office in the licensing of scales independently of the product type. Such a base temperature range, which is comparatively large, lies, for example, between 0° and 40°. The scales may be operated independently of the product type at a low performance licensed by the licensing office independently of the respective product type within such a base temperature range approved by the licensing office. This also applies when the trust temperature range explained above is departed from. The scales may, however, only be operated with a data set determined in accordance with the invention and at a correspondingly higher performance if the ambient temperature determined in the operation of the scales lies both within the trust temperature range and within the base temperature range licensed by the licensing office.

The example of a printout is shown in the following which can be produced by a printer connected to the scales after the parameterization in accordance with the invention has been carried out.

| Teaching and checking of a calibration error limit - | |
|---|---|
| n after PTB licensing | |
| Inspection certificate #:DE-07-MI006-PTB008 | |
| Article number: 1 | |
| Nominal weight 100.0g | |
| Speed 110 m/min | |
| Packaging length 100 mm | |
| Tolerance of pack. length 10 mm | |
| Minimum weight 90.1g | |
| Maximum weight 118.1g | |
| Standard dev. X(1): ok | |
| Mean dev. X(1): ok | |
| No check for Y(a) | |
| Standard dev. X(1) | Act.: 0.09g |

| | |
|---|---|
| . | EFG: 0.24g |
| . | VFG: 0.30g |
| Mean dev.X(1) | Act.:−0.18g |
| . | EFG: 0.25g |
| . | VFG: 0.50g |

| Packaging #1 | Weight: 103.35g | |
|---|---|---|
| 103.20g. | 103.20g | 103.20g |
| 103.15g. | 103.20g | 103.15g |
| 103.15g. | 103.15g | 103.15g |
| 103.15g | | |
| Error limits Y(a): 102.60g. - 104.10g | | |
| Packaging #2 | Weight: 107.40g | |
| 107.20g | 107.20g | 107.15g |
| 107.15g | 107.15g | 107.15g |
| 107.10g | 107.10g | 107.05g |
| 107.05g | | |
| Error limits Y(a): 106.65g - 108.15g | | |
| Packaging #3 | Weight: 100.10g | |
| 100.05g | 100.00g | 100.00g |
| 100.00g | 100.05g | 100.05g |
| 100.00g | 100.00g | 100.05g |
| 100.00g | | |

Error limits Y(a): 99.35g. - 100.85g

At the start of the printout, the product-specific data determined or input in the first step in accordance with the invention are repeated again. They are in this respect an article number which represents a product identification, a nominal weight, a conveying speed, a packaging or product length, a packaging or product length tolerance as well as a minimum weight and a maximum weight. The minimum and maximum weights were determined during the second and/or third steps in accordance with the invention and limit the trust range already explained above and related to the weight, which will be explained in the following.

Below the named data, the result of the verification in accordance with the third step in accordance with the invention is shown in summarized form. It results from the printout shown that the determined standard deviation and the determined mean deviation were within the preset limit values. These limit values are fixed by law, for example, for the territory of Germany as the tolerance error limit (EFG) and as the operational error limit (VFG). In the example case of the above printout, the EFG is 0.24 g and the VFG is 0.30 g. A standard deviation of 0.09 g was determined, that is a value which is less than 0.24 g and also less than 0.30 g so that the preset limit values were observed here.

The same applies accordingly to the mean deviation with respect to which the determined value and the limit values EFG and VFG are set forth in the above printout.

Three sections are included in the lower part of the above printout which relate to the weighing of three different packages (#1, #2 and #3) which took place in the third step in accordance with the invention (verification). The numeric values shown will be explained in the following with reference to packaging #1.

With respect to packaging #1, a correct weight of this packaging was determined at 103.35 g by means of a static weighing procedure. Subsequently, ten dynamic weighing procedures were then carried out within the framework of the verification within which ten different weight values in the range between 103.15 g and 103.20 g were determined. The standard deviation and mean deviation already mentioned above were calculated from these ten values.

Furthermore, absolute calibration error limits, which are in particular relevant to price labelers, are prescribed with respect to the weight of 103.35 g by the laws applicable in Germany. The lower absolute calibration error limit in the present case is 102.60 g; the upper absolute error limit 104.10 g. Since all ten dynamically determined weight values of product #1 are within this range, a check with respect to the absolute calibration error limits would also have a positive outcome in this case. Such a check was, however, not required within the framework of the parameterization in accordance with the above printout so that “No check for Y(a)” is shown in the printout.

The procedure was as follows with respect to the determination of the trust range related to the weight between 90.1 g and 118.1 g:

The greatest and the smallest weight were determined with respect to all three packages weighed. The smallest determined weight (packaging #3) is at 100.10 g; the largest weight (packaging #2) at 107.40 g. The lower limit of the trust range is now calculated in that the named minimum value is reduced by approximately 10% and the named maximum value by approximately 10%.

Within the framework of the data set storage after the verification in accordance with the invention—inter alia also for the purpose of a later check—all the values shown in the printout can be saved, including a check time, with it not being absolutely necessary to save the individual weights determined within the framework of the static and dynamic weighings.

The only FIGURE shows a schematic diagram of an apparatus for the carrying out of the method in accordance with the invention.

A conveyor belt 2 on the ingoing side and a conveyor belt 3 at the offgoing side are adjacent to a weighing belt 1 so that products in a product conveying process move from conveyor belt 2 to the weighing belt 1 and from there to the conveyor belt 3.

The weighing belt 1 is connected to a control unit 4 which has a microprocessor 5 and a memory 6, in which data sets secured against manipulation can be stored, for the carrying out of the method in accordance with the invention.

The control unit 4 is furthermore coupled with an input unit 7 via which, for example, product-specific data can be provided to the control unit 4.

Furthermore, a price labeling system 8 is connected to the control unit 4 and is controlled by the control unit 4 in dependence on the determined weight values. Finally, a temperature sensor 9 is coupled to the control unit 4 which is configured to determine the ambient temperature of the weighing belt 1.

The described components can communicate with one another in the already explained manner and can thus realize the method in accordance with the invention and its preferred embodiments.

1-30. (canceled)

31. A method for the parameterization of scales which have a weighing belt (1) for the weighing of products in a conveying process, wherein
in a first step, product-specific data are input into a control unit (4) which are used for the determination of control parameters;
in a second step, a filter function is determined in an automated manner which is matched to the respective product and which is to be applied to the time-dependent course of a weight signal and at least one product is weighed statically with a stationary weighing belt (1) and dynamically with the weighing belt (1) running;
in a third step, automatic verification is made by means of the weighing of products whether the weight values obtained using the previously determined control parameters and the previously determined filter function lie within preset tolerances;
with a data set which is secured against manipulation and which includes at least the control parameters, the filter function and a product identification only being stored in the control unit (4) with a positive verification.

32. A method in accordance with claim 31, characterized in that the parameterization steps are carried out interactively in a preset order enforced by the control unit (4).

33. A method in accordance with claim 31, characterized in that the product-specific data to be input in the first step include a nominal weight or a nominal weight range, a conveying speed, a product throughput, a product length, a product length tolerance and/or a product identification.

34. A method in accordance with claim 31, characterized in that, during the second step, the weighing belt (1) is operated at the conveying speed input in the first step in the dynamic weighing.

35. A method in accordance with claim 31, characterized in that at least one product is weighed once statically with a stationary weighing belt (1) and multiple times, in particular ten times, dynamically with the weighing belt (1) running during the second step.

36. A method in accordance with claim 31, characterized in that two to five different products, in particular three different products, are weighed in during the second step.

37. A method in accordance with claim 31, characterized in that the product from the number of the products weighed in the second step and from the number of the dynamic weighings of each of these products adopts values between 10 and 200, in particular between 20 and 40.

38. A method in accordance with claim 31, characterized in that the filter function is determined in the second step in dependence on the time-dependent courses of the weight signals determined during the second step and on the input product-specific data.

39. A method in accordance with claim 31, characterized in that at least one product is weighed statically with a stationary weighing belt (1) and dynamically with the weighing belt (1) running during the second step.

40. A method in accordance with claim 39, characterized in that the weighing belt (1) is operated at the conveying speed input in the first step in the dynamic weighing.

41. A method in accordance with claim 31, characterized in that at least one product is weighed once statically with a stationary weighing belt (1) and multiple times, in particular ten times, dynamically with the weighing belt (1) running during the third step.

42. A method in accordance with claim 31, characterized in that two to five different products, in particular three different products, are weighed during the third step.

43. A method in accordance with claim 31, characterized in that the product from the number of the products weighed in the third step and from the number of the dynamic weighings of each of these products adopts values between 10 and 200, in particular between 20 and 40.

44. A method in accordance with claim 31, characterized in that a standard deviation and/or mean deviation are determined for the weight values determined with the dynamic weighing procedures of the third step; and/or in that a determination is made for the weight values determined with the dynamic weighing procedures of the third step whether they are within fixedly preset calibration error limits.

45. A method in accordance with claim 44, characterized in that it is determined at the end of the third step
whether the determined standard deviation and/or mean deviation are within preset limit values and/or
whether the determined weight values are within the fixedly preset tolerance error limits,
with the data set secured against manipulation being stored permanently in the positive case.

46. A method in accordance with claim 31, characterized in that the data set secured against manipulation can be marked as non-activatable, but not completely deleted.

47. A method in accordance with claim 31, characterized in that the data set secured against manipulation additionally includes a verification date, a verification time, a running number related to the respective verification, a user code related to the respective verification and/or at least one check key.

48. A method in accordance with claim 31, characterized in that the data set secured against manipulation or a part thereof is stored on a secured memory medium (6).

49. A method in accordance with claim 31, characterized in that the data set secured against manipulation or a part of the same is stored together with an individually calculated check key.

50. A method for the operation of scales parameterized in accordance with claim 31, characterized in that the scales can only be operated using data sets secured against manipulation or with a low throughput licensed by a licensing office independently of the product type.

51. A method in accordance with claim 50, characterized in that that data set secured against manipulation is activated at the start of operation whose product identification coincides with a product identification input or detected at the start of operation; and/or in that that data set secured against manipulation is activated during operation whose product identification coincides with a product identification located at the product, with the product identification in particular being determined automatically by means of an optical or electronic reading device.

52. A method in accordance with claim 50, characterized in that the scales are used as control scales for the observation of the Prepacked Product Order.

53. A method in accordance with claim 50, characterized in that the scales are used as scales in connection with a price labeling system (8).

54. A method in accordance with claim 31, characterized in that a nominal weight range having an upper limit and a lower limit is input in the parameterization in the first step or an upper limit and a lower limit are determined in the second and/or third steps; and in that only those products are accepted in the operation of the scales whose determined weight does not exceed the upper limit by more than a preset tolerance value or whose determined weight does not fall below the lower limit by more than a preset tolerance value.

55. A method in accordance with claim 54, characterized in that an acceptance takes place when the upper limit is not exceeded by more than x % or the lower limit is not fallen below by more than y %, with 0≦x≦20 and 0≦y≦20 applying.

56. A method in accordance with claim 31, characterized in that a product dimension range having an upper limit and a lower limit is input in the parameterization in the first step or an upper limit and a lower limit are determined in the second and/or third steps; and in that only those products are accepted in the operation of the scales whose determined dimensions do not exceed the upper limit by more than a preset tolerance value or whose determined dimensions do not fall below the lower limit by more than a preset tolerance value.

57. A method in accordance with claim 56, characterized in that an acceptance takes place when the upper limit is not exceeded by more than x % or the lower limit is not fallen below by more than y %, with 0≦x≦20 and 0≦y≦20 applying.

58. A method in accordance with claim 31, characterized in that the ambient temperature given in the parameterization is determined during the parameterization by means of a temperature sensor (9) and an operation of the scales at such temperatures is
either blocked or
is only allowed at a low performance licensed by a licensing office independently of the respective product type
which are outside a temperature range which includes the ambient temperature determined during the parameterization.

59. A method in accordance with claim 58, characterized in that the lower limit of the temperature range is x° C. beneath the ambient temperature determined during the parameterization and the upper limit of the temperature range is y° C. above this ambient temperature, with 1≦x≦10 and 1≦y≦10 applying.
